(19) United States
(12) Patent Application Publication
(10) Pub. No.: US 2011/0102396 A1
(43) Pub. Date: May 5, 2011

(54) ELECTROPHORETIC DISPLAY APPARATUS AND DRIVING METHOD THEREOF, AND ELECTRONIC DEVICE

(75) Inventor: Katsunori YAMAZAKI, Matsumoto (JP)

(73) Assignee: SEIKO EPSON CORPORATION, Tokyo (JP)

(21) Appl. No.: 12/913,820

(22) Filed: Oct. 28, 2010

(30) Foreign Application Priority Data
Oct. 30, 2009 (JP) 2009-250325

(51) Int. Cl. G09G 3/34; G06F 3/038

(52) U.S. Cl. 345/208; 345/211; 345/107

(57) ABSTRACT

An electrophoretic display apparatus is configured with an electrophoretic element sandwiched between a pair of substrates, and includes a scanning line and a data line extending in mutually intersecting directions and a pixel formed corresponding to the area where the scanning line and data line intersect. The pixel includes a pixel electrode, a select transistor whose gate is connected to the scanning line, and a driving transistor whose gate is connected to the data line directly or via another element; and a ramp waveform is inputted into the pixel electrode via the driving transistor.

### BACKGROUND

1. Technical Field

The present invention relates to electrophoretic display apparatuses, driving methods thereof, and electronic devices.

2. Related Art

An active-matrix type electrophoretic display apparatus that includes a driving switching element and a capacitance element for each pixel is known (for example, JP-A-2000-035775).

The electrophoretic display apparatus disclosed in JP-A-2000-035775 is configured so that a voltage to be supplied to row-driving voltage lines is selected using three-state switching elements that are provided for each of the row-driving voltage lines in each row. Accordingly, there has been a problem in that the configuration for driving the row-driving voltage lines has become complex, particularly in the case where multi-tone displays are carried out.

### SUMMARY

An advantage of some aspects of the invention is to provide an electrophoretic display apparatus capable of multi-tone displays without complicating a driving circuit, and to provide a driving method for such an electrophoretic display apparatus.

An electrophoretic display apparatus according to an aspect of the invention is an electrophoretic display apparatus configured with an electrophoretic element sandwiched between a pair of substrates, and including multiple scanning lines and multiple data lines extending in mutually intersecting directions and pixels formed corresponding to the areas where the scanning lines and data lines intersect. A pixel electrode, a select transistor whose gate is connected to the scanning line, and a driving transistor whose gate is connected to the data line directly or via another element, are provided for each pixel; and a ramp waveform is inputted into the pixel electrodes via the driving transistors.

According to this configuration, the potential level of the ramp waveform inputted into the pixel electrode by the driving transistor can be controlled freely, thus making it possible to control the pixel electrode to a desired potential and carry out a multi-tone display. Furthermore, it is unnecessary to provide a voltage selection circuit for each data line, as was the case with electrophoretic display apparatuses in the past. Accordingly, according to the invention, it is possible to realize a multi-tone display without complicating the driving circuit.

A scanning line that is different than the scanning line connected to the pixel or a power source line can be connected to the source of the driving transistor; and the source of the select transistor can be connected to the drain of the driving transistor.

According to this configuration, the electrophoretic display apparatus can be configured so that the electrical connection between the pixel electrode and the driving transistor is switched by the select transistor and the potential of the ramp waveform inputted to the pixel electrode by the driving transistor is controlled.

A scanning line that is different than the scanning line connected to the pixel or a power source line can be connected to the source of the driving transistor; and the drain of the select transistor can be connected to the gate of the driving transistor.

According to this configuration, the electrophoretic display apparatus can be configured so that the on period of the driving transistor is controlled by a signal inputted into the gate of the driving transistor via the select transistor, through which the potential of the ramp waveform inputted into the pixel electrode is controlled.

It is preferable for the scanning line that is connected to the driving transistor to be adjacent to the scanning line connected to the pixel.

According to this configuration, the ramp waveform inputted to the scanning line of the stated adjacent row and the selection signal (a potential that puts the select transistor in an on state) can be formed as a single waveform, thus making it possible to avoid complicating the configuration of the scanning line driving circuit.

It is preferable for the configuration to be such that a pulse having a pulse width that is no greater than a selection period of the pixel is inputted into the gate of the driving transistor. According to such a configuration, it is easy to realize a configuration in which a given potential is selected from the potential of the ramp waveform that changes over time and is inputted into the pixel electrode.

It is preferable for the ramp waveform to be supplied to the pixel only during a period during which a potential that puts the select transistor into an on state is inputted into the scanning line.

Through this, it is possible to supply the ramp waveform selectively only to the pixels for which display operations are carried out, which in turn makes it possible to suppress power consumption caused by the charging and discharging of parasitic capacitance between the line that supplies the ramp waveform and other lines.

It is preferable for a power source main line that supplies the ramp waveform to a display unit and power source lines that are formed in correspondence with the scanning lines in each row and that supply the ramp waveform to the pixels that belong to the scanning lines to be provided; the respective power source lines to be connected to the power source main line via a power source unit transistor; and the scanning lines to be connected to the gate of the power source unit transistor.

According to this configuration, the ramp waveform is supplied to the respective power source lines from the power source main line only when the scanning line is selected, thus making it possible to reduce the portions where the charging and discharging of parasitic capacitance caused by the ramp waveform whose potential fluctuates frequently occur; this makes it possible to suppress the power consumption.

Next, a driving method for an electrophoretic display apparatus according to another aspect of the invention is a driving method for an electrophoretic display apparatus, the electrophoretic display apparatus configured with an electrophoretic element sandwiched between a pair of substrates and including multiple scanning lines and multiple data lines extending in mutually intersecting directions and pixels formed corresponding to the areas where the scanning lines and data lines intersect, and being provided with a pixel electrode, a select transistor whose gate is connected to the scanning line, and a driving transistor whose gate is connected to the data line directly or via another element for each pixel, the method including, when an image is displayed in a display unit: putting the pixel in a selected state by putting the select transistor into an on state in a state where a ramp waveform is supplied to the source of the driving transistor; and inputting part or all of the ramp waveform into the pixel electrode by selectively putting the driving transistor into an on state during a predetermined period while the select transistor is in an on state.

According to this driving method, it is possible to freely control a potential inputted into the pixel electrode by controlling the driving transistor on and off while inputting the ramp waveform into the pixel electrode. Furthermore, it is unnecessary to provide a voltage selection circuit for each data line, as was the case with electrophoretic display apparatuses in the past. Accordingly, according to the invention, it is possible to realize a multi-tone display without requiring a complicated driving circuit.

It is preferable for the ramp waveform to be supplied to the driving transistor via a scanning line that is different than the scanning line connected to the pixel.

Accordingly, it is not necessary to provide a separate power source line that supplies the ramp waveform, and thus the driving method is one that can be applied in an electrophoretic display apparatus without significantly changing the display unit from its past configuration.

It is preferable for the ramp waveform to be supplied to the driving transistor from the scanning line that is in the adjacent row relative to the pixel.

Through this, the driving method can suppress the complication of the scanning line driving circuit.

An electronic device according to another aspect of the invention includes the electrophoretic display apparatus described above.

According to this configuration, a display unit capable of multi-tone displays using a driving circuit having a simple configuration is provided, thus making it possible to realize an electronic device that can be provided at a low price.

### BRIEF DESCRIPTION OF THE DRAWINGS

The invention will be described with reference to the accompanying drawings, wherein like numbers reference like elements.

FIG. 1 is a diagram illustrating the overall configuration of an electrophoretic display apparatus according to a first embodiment.

FIGS. 2A and 2B are diagrams illustrating the planar configurations of a pixel circuit and a pixel.

FIGS. 3A and 3B are cross-sectional views illustrating the primary elements of an electrophoretic display apparatus according to the first embodiment.

FIGS. 4A and 4B are descriptive diagrams illustrating operations of an electrophoretic element.

FIG. 5 is a timing chart illustrating a driving method according to the first embodiment.

FIG. 6 is a diagram illustrating a pixel circuit according to a variation.

FIGS. 7A and 7B are diagrams illustrating the planar configurations of a pixel circuit and a pixel according to a second embodiment.

FIG. 8 is a timing chart illustrating a driving method according to the second embodiment.

FIG. 9 is a diagram illustrating a pixel circuit according to a third embodiment.

FIG. 10 is a diagram illustrating an example of an electronic device.

FIG. 11 is a diagram illustrating an example of an electronic device.

FIG. 12 is a diagram illustrating an example of an electronic device.

### DESCRIPTION OF EXEMPLARY EMBODIMENTS

Hereinafter, embodiments of the invention will be described using the drawings.

Note that the scope of the invention is not intended to be limited to the embodiments described hereinafter, and various modifications can be made within this scope without departing from the technical spirit of the invention. Furthermore, to facilitate understanding of the various structures, there are cases where the scale, numbers, and so on of the various structures depicted in the drawings differ from those of the actual structures.

### First Embodiment

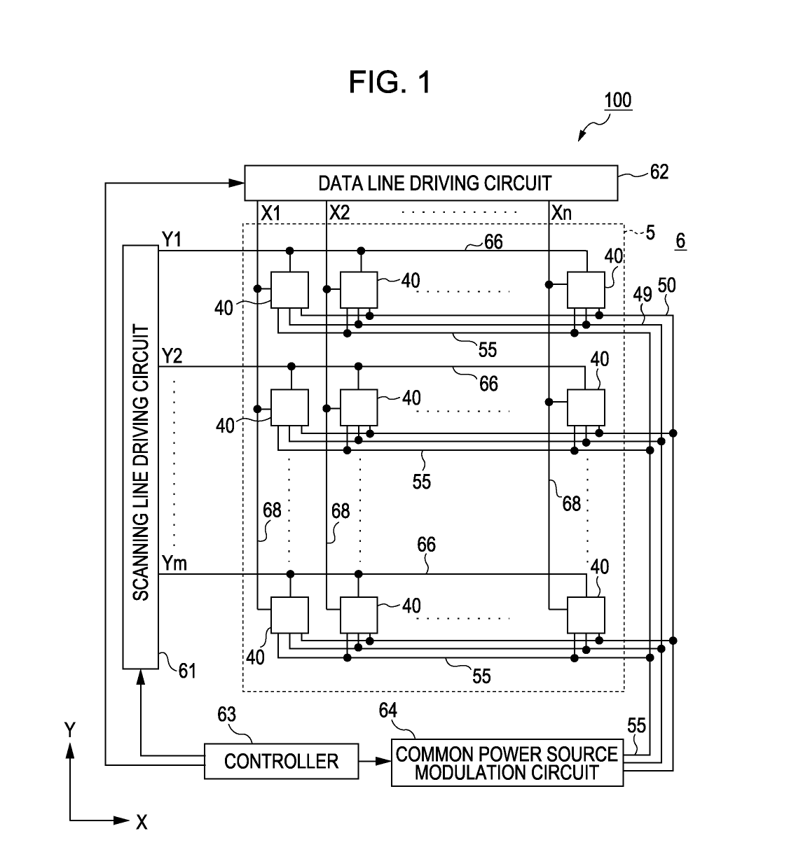

FIG. 1 is a diagram illustrating the overall configuration of an electrophoretic display apparatus 100 embodying the invention.

The electrophoretic display apparatus 100 includes a display unit 5 in which multiple pixels 40 are arranged in the form of a matrix. A scanning line driving circuit 61, a data line driving circuit 62, a controller (control unit) 63, and a common power source modulation circuit 64 are disposed in the periphery of the display unit 5. The scanning line driving circuit 61, data line driving circuit 62, and common power source modulation circuit 64 are each connected to the controller 63. The controller 63 performs overall control of these circuits based on image data, synchronization signals, and so on supplied from a host device.

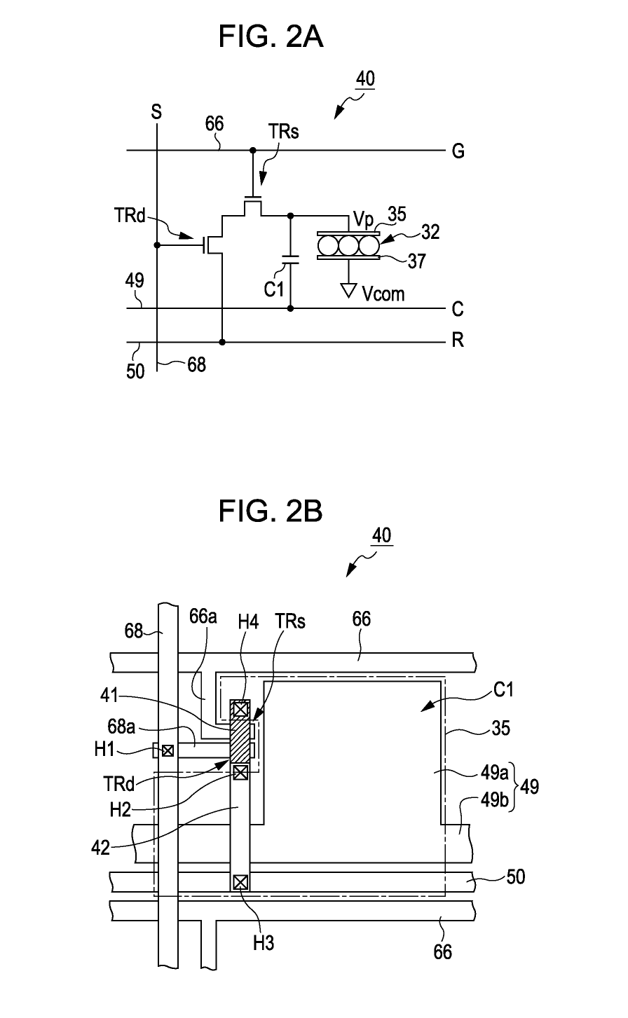

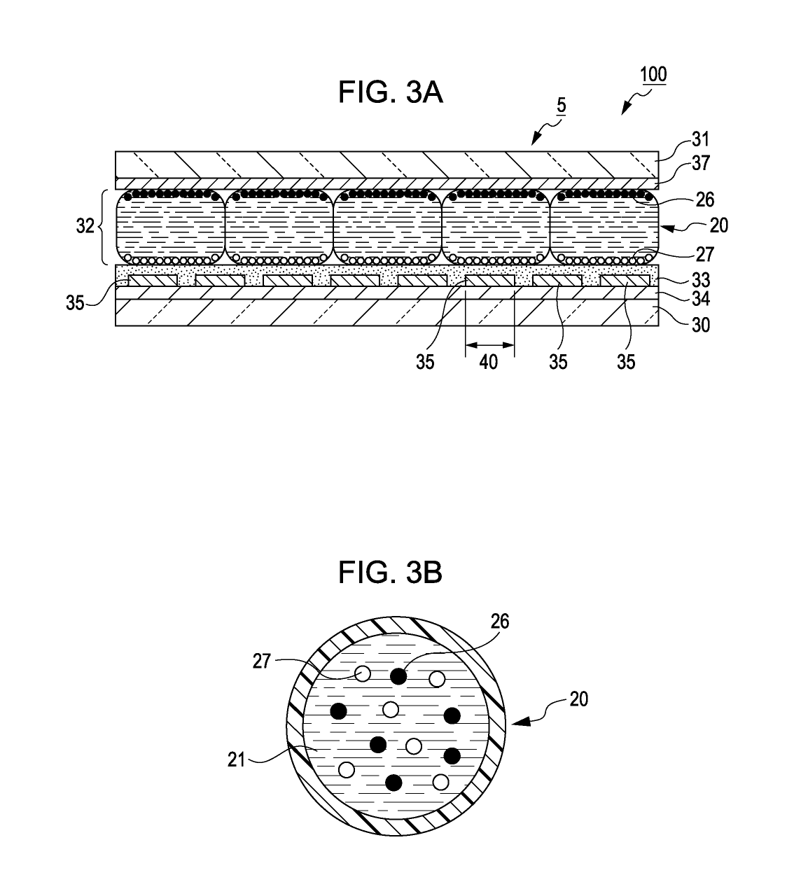

Multiple scanning lines 66 extending from the scanning line driving circuit 61 and multiple data lines 68 extending from the data line driving circuit 62 are formed in the display unit 5, and pixels 40 are provided corresponding to each position where the respective lines intersect. Furthermore, a capacitance line 49, a power source line 50, and a common electrode wire 55 are provided extending from the common power source modulation circuit 64, and each of these wires is connected to the pixels 40. Note that the common electrode wire 55 is indicated as a wire for electrically connecting a common electrode 37, which is an electrode that is common for the multiple pixels 40 of the display unit 5 (see FIGS. 2 and 3), to the common power source modulation circuit 64 in a simple manner.

The scanning line driving circuit 61 is connected to each of the pixels 40 via m scanning lines 66 (Y1, Y2, and so on up to Ym); under the control of the controller 63, the scanning lines 66 are selected in order from the first row to the mth row, and a selection signal that defines the on timing of select transistors TRs provided in the pixels 40 (see FIG. 2) is supplied via the selected scanning line 66. The data line driving circuit 62 is connected to each of the pixels 40 via n data lines 68 (X1, X2, and so on up to Xn), and under the control of the controller 63, supplies image signals defining pixel data corresponding to the respective pixels 40 to those pixels 40. Under the control of the controller 63, the common power source modulation circuit 64 generates various types of signals to be supplied to the aforementioned respective wires, while also electrically connecting and disconnecting the respective wires (putting the wires at high-impedance (Hi-Z)).

FIG. 2A is a diagram illustrating the circuit structure of the pixels 40.

Each pixel 40 is provided with the select transistor TRs, a driving transistor TRd, a holding capacitor C1, a pixel electrode 35, an electrophoretic element 32, and the common electrode 37. The scanning lines 66, data lines 68, capacitance line 49, and power source line 50 are connected to the respective pixels 40. The select transistor TRs and driving transistor TRd are both N-MOS (Negative Metal Oxide Semiconductor) transistors.

Note that the select transistor TRs and the driving transistor TRd may be replaced with other types of switching elements having the same functionality thereas. For example, a P-MOS transistor may be used instead of an N-MOS transistor, and inverters or transmission gates may be used as well.

The scanning line 66 is connected to the gate of the select transistor TRs, whereas the drain of the driving transistor TRd is connected to the source of the select transistor TRs and the holding capacitor C1 and the pixel electrode 35 are connected to the drain of the select transistor TRs. The gate of the driving transistor TRd is connected to the data line 68, whereas the source of the driving transistor TRd is connected to the power source line 50. The other electrode of the holding capacitor C1 is connected to the capacitance line 49. The electrophoretic element 32 is sandwiched between the pixel electrode 35 and the common electrode 37.

In the pixel 40, the select transistor TRs is a pixel switching element that controls (permits or prohibits) the input of a potential to the pixel electrode 35, whereas the driving transistor TRd is a switching element that controls the input of a power source potential supplied from the power source line 50 into the select transistor TRs. During the period when the select transistor TRs is placed in an on state by the selection signal inputted via the scanning line 66 and the driving transistor TRd is placed in an on state by the image signal inputted via the data line 68, the power source potential of the power source line 50 is inputted into the pixel electrode 35 via the driving transistor TRd and the select transistor TRs. In addition, the holding capacitor C1 is charged by the power source potential.

FIG. 2B is a diagram illustrating a specific example of the planar configuration of the pixel 40. As shown in FIG. 2B, the data lines 68 and scanning lines 66 extend vertically and horizontally, respectively, in the pixel 40, and the select transistor TRs, the driving transistor TRd, the pixel electrode 35, a capacitor electrode portion 49a, and so on are formed in the region surrounded by those wires.

A semiconductor layer 41 configured of polycrystal silicon, amorphous silicon, or the like is formed in the pixel 40; a gate electrode 66a that branches off from the scanning line 66 in an L shape when viewed from above and a gate electrode 68a formed through a connection with the data line 68 via a contact hole H1 are formed in locations that partially overlap with the semiconductor layer 41. One end of the semiconductor layer 41 is connected to a connection wire portion 42 via a contact hole H2, whereas the end of the connection wire portion 42 on the opposite side with respect to the semiconductor layer 41 is connected to the power source line 50 via a contact hole H3. The power source line 50 is formed as a wire that extends along the scanning line 66.

The other end of the semiconductor layer 41 is connected to the pixel electrode 35 via a contact hole H4. The capacitor electrode portion 49a is formed in a region that overlaps with the pixel electrode 35 when viewed from above. Wire portions 49b extend from both ends of the capacitor electrode portion 49a along the direction of the scanning line 66, and connect to the capacitor electrode portions 49a of the other adjacent pixels 40. These multiple capacitor electrode portions 49a and multiple wire portions 49b configure the capacitance line 49.

The holding capacitor C1 is formed in a region where the pixel electrode 35 and the capacitance line 49 (capacitor electrode portion 49a and wire portion 49b) overlap with each other when viewed from above.

Next, FIG. 3A is a partial cross-sectional view illustrating the electrophoretic display apparatus 100 in the display unit 5. The electrophoretic display apparatus 100 has a configuration in which the electrophoretic element 32, which is configured by arranging multiple microcapsules 20, is sandwiched between an element substrate (a first substrate) 30 and an opposing substrate (a second substrate) 31.

In the display unit 5, a circuit layer 34 in which the scanning lines 66, the data lines 68, the select transistors TRs, the driving transistors TRd, and so on illustrated in FIGS. 1 through 2B are formed is provided on the side of the electrophoretic element 32 that faces the element substrate 30, and multiple pixel electrodes 35 are formed in an arrangement upon the circuit layer 34.

The element substrate 30 is a substrate formed of glass, plastic, or the like, and need not be transparent due to its being disposed on the side opposite to the image display surface. The pixel electrode 35 is an electrode that applies a voltage to the electrophoretic element 32, and is formed by layering a nickel plating and a gold plating in that order upon a Cu (copper) foil, or is formed of Al (aluminum), ITO (indium tin oxide), or the like.

On the other hand, the flat common electrode 37 is formed on the side of the electrophoretic element 32 that faces the opposing substrate 31, opposing the multiple pixel electrodes 35, and the electrophoretic element 32 is provided upon the common electrode 37.

The opposing substrate 31 is a substrate formed of glass, plastic, or the like, and is a transparent substrate due to its being disposed on the image display side. Like the pixel electrodes 35, the common electrode 37 is an electrode that applies a voltage to the electrophoretic element 32, and is a transparent electrode formed of MgAg (magnesium-silver), ITO (indium tin oxide), IZO (indium zinc oxide), or the like.

The element substrate 30 and the opposing substrate 31 are affixed together by bonding the electrophoretic element 32 and the pixel electrodes 35 using an adhesive layer 33.

Note that generally, the electrophoretic element 32 is pre-formed on the side of the opposing substrate 31 and is handled as an electrophoretic sheet that includes up to the adhesive layer 33. During the manufacturing process, the electrophoretic sheet is handled in a state in which a protective removable sheet is affixed to the surface of the adhesive layer 33. The display unit 5 is then formed by removing the removable sheet and bonding the electrophoretic sheet to the element substrate 30 (in which are formed the pixel electrodes 35, various types of circuits, and so on), which has been manufactured separately. Accordingly, the adhesive layer 33 is present only on the pixel electrode 35 side.

FIG. 3B is a schematic cross-sectional view of the microcapsule 20. Each microcapsule 20 is a spherical body, having a particle diameter of, for example, approximately 50 μm, in the interior of which a dispersion medium 21, multiple white particles (electrophoretic particles) 27, and multiple black particles (electrophoretic particles) 26 have been injected. As shown in FIG. 3A, the microcapsules 20 are sandwiched between the common electrode 37 and the pixel electrodes 35, and one or more microcapsules 20 are disposed within a single pixel 40.

The casing (wall membrane) of each microcapsule 20 is formed using an acrylic resin such as polymethyl methacrylate, polyethyl methacrylate, or the like, or a translucent high-polymer resin such as urea formaldehyde resin, gum arabic, or the like.

The dispersion medium 21 is a liquid in which the white particles 27 and the black particles 26 are dispersed within the microcapsule 20. Water, alcohol solvents (methanol, ethanol, isopropanol, butanol, octanol, methyl cellosolve, and so on), esters (ethyl acetate, butyl acetate, and so on), ketones (acetone, methyl ethyl ketone, methyl isobutyl ketone, and so on), aliphatic hydrocarbons (pentane, hexane, octane, and so on), alicyclic hydrocarbons (cyclo-hexane, methyl cyclo-hexane, and so on), aromatic hydrocarbons (benzene, toluene, benzenes having long-chain alkyl groups (xylene, hexyl-benzene, heptyl-benzene, octyl-benzene, nonyl benzene, decyl benzene, undecyl benzene, dodecyl-benzene, tridecyl-benzene, and tetradecyl-benzene)), halogenated hydrocarbons (methylene chloride, chloroform, carbon tetrachloride, 1,2-dichloroethane, and so on), carboxylate, and so on can be given as examples of the dispersion medium 21; other oils may be employed as well. These materials may be used alone or as mixtures, and surface-active agents may be added thereto as well.

The white particles 27 are particles (high-polymers or colloids) configured of a white pigment such as, for example, titanium dioxide, hydrozincite, antimony trioxide, or the like, and are used in, for example, a negatively-charged state. The black particles 26, meanwhile, are particles (high-polymers or colloids) configured of a black pigment such as, for example, aniline black, carbon black, or the like, and are used in, for example, a positively-charged state.

Charge control agents configured of particles of electrolytes, surface-active agents, metallic soaps, resins, rubbers, oils, varnishes, or the like, dispersants such as titanium coupling agents, aluminum coupling agents, and silane coupling agents, lubricant agents, stabilizing agents, and so on may be added to these pigments as necessary.

In addition, red, green, blue, or other such pigments may be used instead of the black particles 26 and the white particles 27. Based on such a configuration, it is possible to display red, green, blue, or other such colors in the display unit 5.

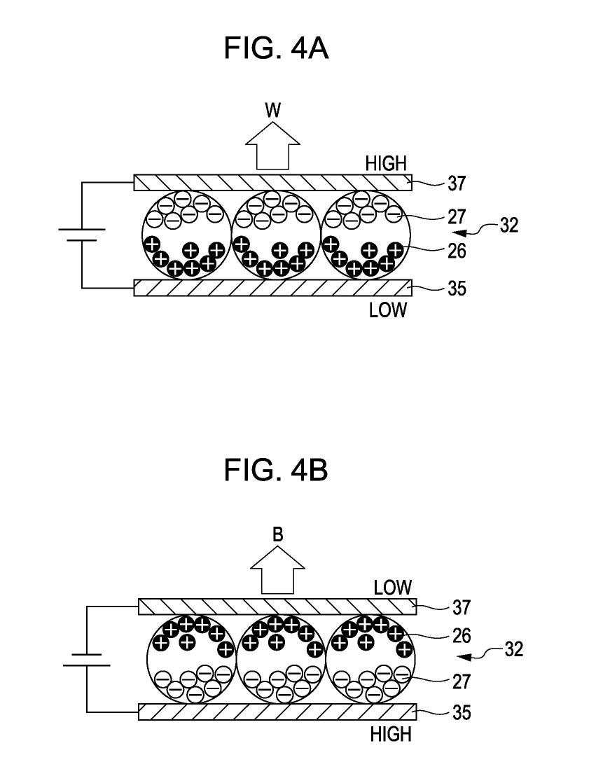

FIGS. 4A and 4B are descriptive diagrams illustrating operations of the electrophoretic element. FIG. 4A illustrates a case where the pixel 40 displays white, whereas FIG. 4B illustrates a case where the pixel 40 displays black.

In the case of the white display shown in FIG. 4A, the common electrode 37 is held at a relatively high potential, whereas the pixel electrode 35 is held at a relatively low potential. Accordingly, the negatively-charged white particles 27 are pulled toward the common electrode 37, whereas the positively-charged black particles 26 are pulled toward the pixel electrode 35. As a result, when the pixel is viewed from the side of the common electrode 37, which is the display surface side, a white color (W) is seen.

In the case of the black display shown in FIG. 4B, the common electrode 37 is held at a relatively low potential, whereas the pixel electrode 35 is held at a relatively high potential. Accordingly, the positively-charged black particles 26 are pulled toward the common electrode 37, whereas the negatively-charged white particles 27 are pulled toward the pixel electrode 35. As a result, when the pixel is viewed from the side of the common electrode 37, a black color (B) is seen.

### Driving Method

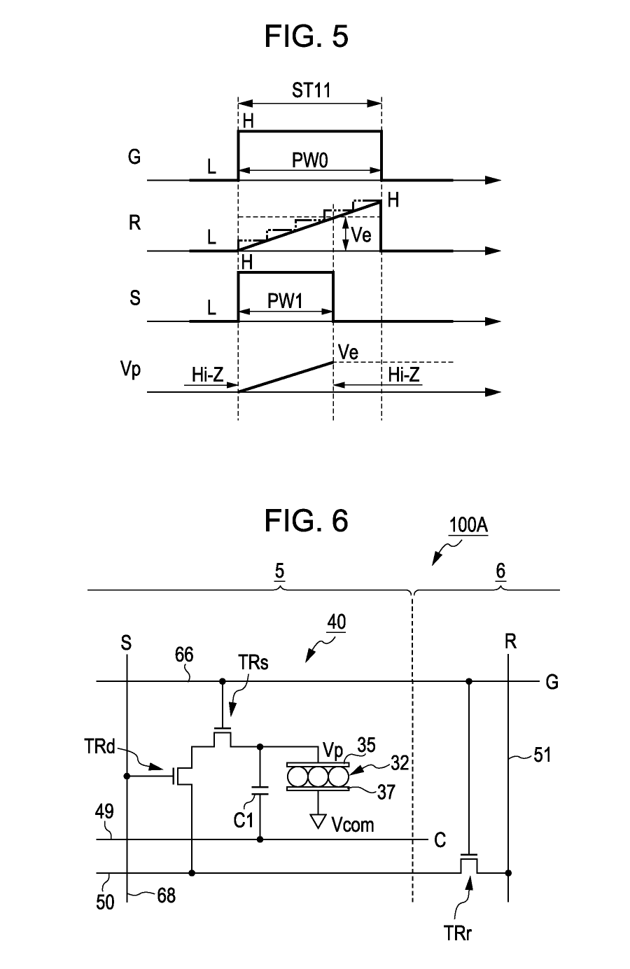

Next, a driving method of the electrophoretic display apparatus according to this embodiment will be described with reference to FIG. 5.

FIG. 5 is a timing chart illustrating a driving method of the electrophoretic display apparatus 100. FIG. 5 illustrates potential changes in the scanning line 66 (potential G), the power source line 50 (potential R), the data line 68 (potential S), and a pixel electrode 35 (potential Vp) for a single pixel 40 during an image display period ST11 in which an image is displayed in the display unit 5 of the electrophoretic display apparatus 100.

During the image display period ST11, the scanning lines 66 in each row are sequentially selected by the scanning line driving circuit 61. As shown in FIG. 5, a potential (high-level) that puts the select transistor TRs into an on state is inputted into the selected scanning line 66 (potential G). In addition, a potential (high-level) that puts the driving transistor TRd into an on state is inputted into the data lines 68 (potential S) in each column, in synchronization with the selection operation of the scanning line 66. Furthermore, a ramp waveform is supplied to the power source line 50 (potential R) in synchronization with the selection operation of the scanning line 66.

Here, the stated ramp waveform is a waveform in which the potential level gradually changes across the image display period ST11, and in the example shown in FIG. 5, is a waveform in which the potential R changes linearly from a low-level to a high-level from the start to the end of the image display period ST11. However, the ramp waveform supplied to the power source line 50 may be a step-shaped waveform, as indicated by the double-dot-dash line in FIG. 5. Alternatively, the ramp waveform may be a waveform in which the potential decreases linearly from the start to the end of the image display period ST11. Or, the ramp waveform may be a waveform in which the potential changes as a curve, such as a logarithmic curve, an exponential curve, and so on.

In this embodiment, during the aforementioned operations, a pulse width PW1 of a rectangular pulse inputted into the data line 68 is set to a desired length within the range of a selection period PW0 (the pulse width of a selection signal) of the scanning line 66, as shown in FIG. 5. Through this, the driving transistor TRd enters an off state when the potential of the ramp waveform inputted into the driving transistor TRd via the power source line 50 reaches a predetermined value (in FIG. 5, a potential Ve), thus making it possible to set the potential Vp of the pixel electrode 35 to the potential Ve. After this, because the driving transistor TRd is put into the off state, the pixel electrode 35 enters a high-impedance state, and the potential Ve of the pixel electrode 35 is held by the energy accumulated in the holding capacitor C1. Through this, the electrophoretic element 32 is driven based on the potential difference between the pixel electrode 35 and the common electrode 37, making it possible to achieve the display of a desired tone.

In this manner, in this embodiment, a given potential can be selected from the ramp waveform that changes over time during the selection period, depending on the pulse width PW1 of the image signal inputted into the data line 68, and the selected potential can then be inputted into the pixel electrode 35. This makes it possible to realize a multi-tone display without providing a circuit for supplying multiple different potentials to the respective data lines.

Meanwhile, because the image signal inputted into the data line 68 is a pulse width-modulated waveform, two-value control is possible, thus rendering a complex driving circuit unnecessary. In this embodiment, a ramp waveform inputted into the power source line 50 is used, but as shown in FIG. 1, because the power source line 50 is a wire that is common among all of the pixels 40 in the display unit 5, only a single circuit is necessary to drive the power source line 50, and thus the circuit configuration is not complicated.

### Variation

FIG. 6 is a diagram illustrating the overall configuration of an electrophoretic display apparatus 100A according to a variation on the first embodiment.

With the electrophoretic display apparatus 100A according to the variation, as shown in FIG. 6, a power source line 50 is provided corresponding to the scanning line 66 in each row of the display unit 5, and the power source lines 50 are connected, via power source unit transistors TRr, to a power source main line 51 at locations extending from the display unit 5 into a non-display unit 6. The gates of the power source unit transistors TRr are connected to the scanning lines 66 corresponding to the power source lines 50 that are connected to the drains of the power source unit transistors TRr. The sources of the power source unit transistors TRr are connected to the power source main line 51.

With the electrophoretic display apparatus 100A according to the variation configured as described above, a ramp waveform is inputted into the power source line 50 in synchronization with the selection operations of the scanning lines 66. In other words, the power source unit transistor TRr enters an on state, so that the power source line 50 and power source main line 51 are electrically connected, and the ramp waveform is supplied to the driving transistor TRd via the power source line 50 only for the period during which a potential that sets the select transistor TRs to an on state (a high-level potential) is inputted into the scanning line 66. Then, when the scanning line 66 transitions to a non-selected state, the power source unit transistor TRr enters an off state and the power source line 50 enters a high-impedance state.

In the case where, as shown in FIG. 1, a single power source line 50 is provided throughout the display unit 5 and is connected to the respective pixels 40, the power source line 50 crosses the data lines 68 in multiple locations (the same number as that of the scanning lines 66); parasitic capacitance at these crossing portions is charged and discharged due to the change in potential of the ramp waveform, consuming a great amount of energy as a result. As opposed to this, while the electrophoretic display apparatus 100A according to the variation is similar in that multiple power source lines 50 cross the data lines 68, there is, during operation, normally only one power source line 50 into which the ramp waveform is inputted, and thus the power consumption caused by parasitic capacitance between the power source lines 50 and the data lines 68 can be greatly reduced. Furthermore, in the case of the variation, almost all of the power source lines 50 are in a high-impedance state, and thus the charging and discharging of the parasitic capacitance arising due to changes in the potential of the data lines 68 is greatly reduced.

In this manner, with the electrophoretic display apparatus 100A according to the variation, the power consumption can be reduced more than with the apparatus described earlier in the first embodiment.

### Second Embodiment

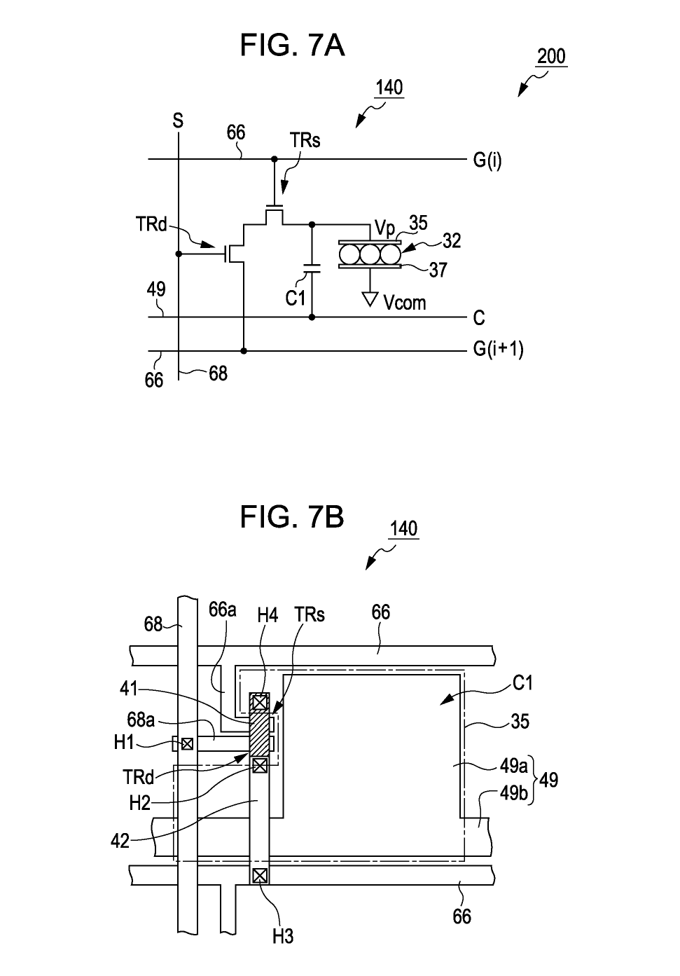

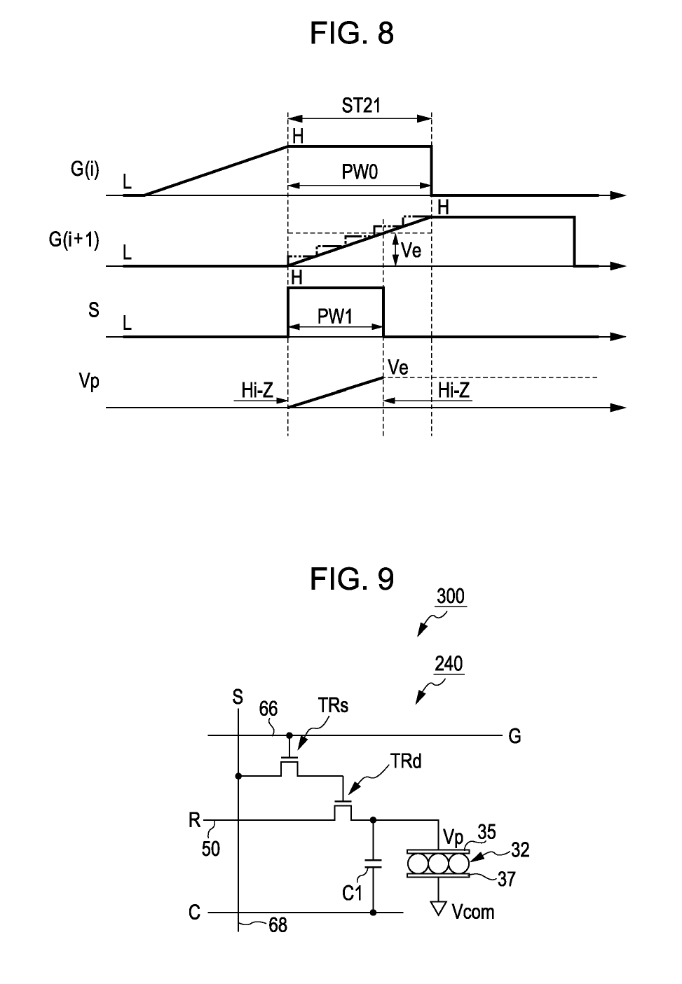

FIGS. 7A and 7B are diagrams illustrating the planar configuration of a pixel circuit and a pixel in an electrophoretic display apparatus 200 according to a second embodiment of the invention. FIG. 8 is a timing chart illustrating a driving method according to the second embodiment. FIG. 8 illustrates the potential changes of an ith (where 1≦i≦m) scanning line 66 (potential G(i)), an (i+1)th scanning line 66 (potential G(i+1)), a data line 68 (potential S), and a pixel electrode 35 (potential Vp) for a single pixel 140 during an image display period ST21 when an image is displayed in the display unit 5 of the electrophoretic display apparatus 200. Note that the (i+1)th scanning line 66 is the scanning line 66 selected after the ith scanning line 66 during the selection operations of the scanning line driving circuit 61. Note also that an (m+1)th dummy scanning line 66, which does not contribute to the actual display, is provided for the case row i=m.

As shown in FIG. 7A, the pixel 140 of the electrophoretic display apparatus 200 according to this embodiment is configured so that the source of the driving transistor TRd is connected to the scanning line 66 in the next row. Accordingly, the power source line 50, provided as a wire separate from the scanning line 66 in the first embodiment, has been omitted. The power source line 50 has been omitted from the planar configuration of the pixel illustrated in FIG. 7B as well, and the connection wire portion 42 connected to the semiconductor layer 41 via the contact hole H2 is connected to the scanning line 66 in the next row via the contact hole H3.

A similar multi-tone display as that provided by the electrophoretic display apparatus 100 of the first embodiment can also be achieved by the electrophoretic display apparatus 200 having the stated configuration. To be more specific, as shown in FIG. 8, a waveform that combines a ramp waveform with a rectangular pulse is inputted into the scanning lines 66. Of the pulse inputted into the scanning lines 66, the rectangular wave portion is a signal (selection signal) that puts the select transistors TRs into an on state, whereas the ramp waveform portion, in which the potential gradually changes, is a signal (power source) inputted into the pixel electrodes 35 via the driving transistors TRd.

In the image display period ST21 shown in FIG. 8, an image display operation for the first pixel 140 belonging to the ith scanning line 66 is carried out. In the image display period ST21, a potential (high-level) that puts the select transistor TRs into an on state is inputted into the ith scanning line 66. At this time, a ramp waveform in which the potential gradually rises throughout the image display period ST21 is inputted into the following (i+1)th scanning line 66.

Then, a potential (high-level) that puts the driving transistor TRd into an on state is inputted into the data lines 68 (potential S) in each column, in synchronization with the selection operation of the scanning line 66. The pulse width PW1 of the rectangular pulse that is inputted into the data lines 68 is, as shown in FIG. 8, set to a desired length within the range of the selection period PW0 of the scanning lines 66.

Through the stated operations, the driving transistor TRd enters an off state when the potential of the ramp waveform inputted into the driving transistor TRd via the (i+1)th scanning line 66 reaches a predetermined value (in FIG. 8, the potential Ve), thus making it possible to set the potential Vp of the pixel electrode 35 to the potential Ve. After this, because the driving transistor TRd is put into the off state, the pixel electrode 35 enters a high-impedance state, and the potential Ve of the pixel electrode 35 is held by the energy accumulated in the holding capacitor C1. Through this, the electrophoretic element 32 is driven based on the potential difference between the pixel electrode 35 and the common electrode 37, making it possible to achieve the display of a desired tone.

Accordingly, like the electrophoretic display apparatus 100 of the first embodiment, the electrophoretic display apparatus 200 of the second embodiment is capable of carrying out a multi-tone display without complicating the configuration of the driving circuit. In addition, in this embodiment, only the selected scanning line 66 and the scanning line 66 in the next row are driven at the same time, and thus similar energy conservation to that achieved by the electrophoretic display apparatus 100A according to the variation on the first embodiment can be realized as well. Furthermore, in this embodiment, the power source line 50 according to the first embodiment is unnecessary, and thus there is a benefit in that it is easier to accommodate a movement towards the miniaturization of pixels.

Although the aforementioned embodiment discusses supplying the ramp waveform to the driving transistor TRd via the scanning line 66 of an adjacent row, it should be noted that a scanning line 66 from a non-adjacent row can be used for the stated supply of the ramp waveform as long as it is a scanning line 66 aside from that row. However, as shown in FIG. 8, the selection signal and the ramp waveform can be supplied as a single continuous waveform in the case where the scanning line 66 of the adjacent row is used, which makes it possible to suppress an increase in the complexity of the scanning line driving circuit 61.

### Third Embodiment

FIG. 9 is a diagram illustrating a pixel circuit in an electrophoretic display apparatus 300 according to a third embodiment of the invention.

As shown in FIG. 9, a pixel 240 of the electrophoretic display apparatus 300 according to this embodiment includes the select transistor TRs, the driving transistor TRd, the pixel electrode 35, the electrophoretic element 32, the common electrode 37, and the holding capacitor C1. The scanning line 66, data line 68, and power source line 50 are connected to the pixel 240.

The scanning line 66 is connected to the gate of the select transistor TRs, whereas the data line 68 is connected to the source and the gate of the driving transistor TRd is connected to the drain. The power source line 50 is connected to the source of the driving transistor TRd, whereas the pixel electrode 35 is connected to the drain. As in the aforementioned first embodiment, a ramp waveform is supplied to the power source line 50. With respect to the holding capacitor C1, one electrode of the holding capacitor is connected to the point between the drain of the driving transistor TRd and the pixel electrode 35, whereas the other electrode thereof is connected to a constant potential line such as a capacitance line or the like.

The electrophoretic display apparatus 300 configured as described above can achieve a similar multi-tone display as in the first embodiment by using a similar driving method as that used with the electrophoretic display apparatus 100 of the first embodiment illustrated in FIG. 5.

In other words, during the image display operation, a potential (high-level) that puts the select transistor TRs into an on state is inputted into the scanning line 66, and in synchronization therewith, an image signal is inputted into the data line 68. This image signal is a rectangular wave set to a pulse width PW1 of a desired length within the range of the selection period PW0 of the scanning line 66.

By doing so, the image signal is inputted into the gate of the driving transistor TRd via the select transistor TRs that is in the on state, and the driving transistor TRd is in an on state only during the period when the image signal is being inputted (the pulse width PW1). Accordingly, the driving transistor TRd enters an off state when the potential of the ramp waveform supplied from the power source line 50 reaches a desired potential Ve, thus making it possible to set the potential Vp of the pixel electrode 35 to the potential Ve. After this, because the driving transistor TRd is put into the off state, the pixel electrode 35 enters a high-impedance state, and the potential Ve of the pixel electrode 35 is held by the energy accumulated in the holding capacitor C1. Through this, the electrophoretic element 32 is driven based on the potential difference between the pixel electrode 35 and the common electrode 37, making it possible to achieve the display of a desired tone.

Accordingly, like the electrophoretic display apparatus 100 of the first embodiment, the electrophoretic display apparatus 300 of the third embodiment is capable of carrying out a multi-tone display without complicating the configuration of the driving circuit.

The configuration of the variation on the first embodiment or the configuration of the second embodiment can also be applied to the electrophoretic display apparatus 300 of this embodiment. Employing these configurations makes it possible to achieve energy conservation in the electrophoretic display apparatus 300. Furthermore, if the same configuration as that of the second embodiment is applied, the power source line 50 is unnecessary, and thus there is a further benefit in that it is easier to accommodate a movement towards the miniaturization of pixels.

### Electronic Device

Next, a case in which the electrophoretic display apparatus 100, 100A, 200, or 300 according to the aforementioned embodiments is applied in an electronic device will be described.

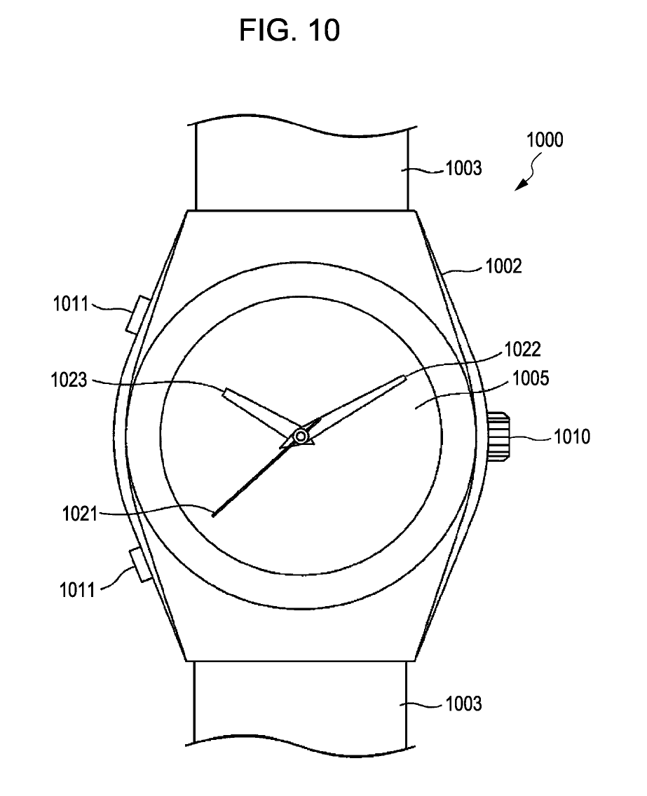

FIG. 10 is a frontal view of a wristwatch 1000. The wristwatch 1000 includes a watch casing 1002 and a pair of bands 1003 that are connected to the watch casing 1002.

A display unit 1005 configured of the electrophoretic display apparatus according to the aforementioned embodiments, a second hand 1021, a minute hand 1022, and an hour hand 1023 are provided on the front surface of the watch casing 1002. A crown 1010 and operational buttons 1011, serving as operational elements, are provided on a side surface of the watch casing 1002. The crown 1010 is connected to a setting stem (not shown) provided in the interior of the casing, and is provided integrally with the setting stem so as to be pushable/pullable across multiple (for example, two) steps and freely rotatable. With the display unit 1005, an image serving as a background, a character string such as a date or time, or the second hand, minute hand, hour hand, or the like can be displayed.

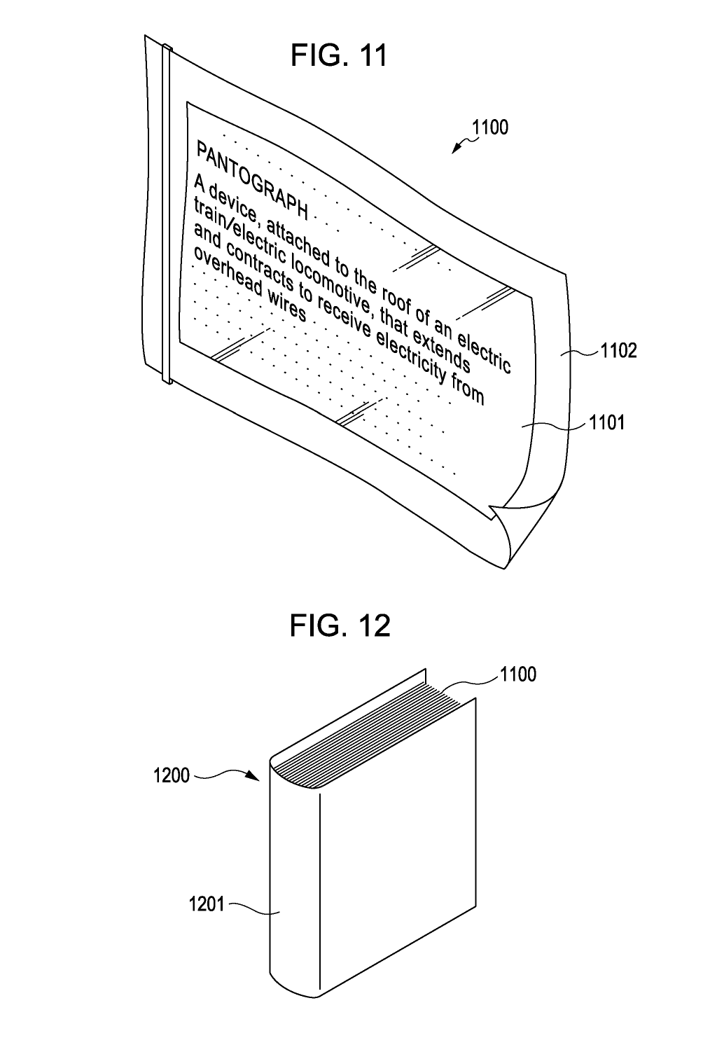

FIG. 11 is a perspective view illustrating the configuration of electronic paper 1100. The electronic paper 1100 includes the electrophoretic display apparatus of the aforementioned embodiments in a display region 1101. The electronic paper 1100 is flexible, and is configured so as to include a main body portion 1102 with a rewritable sheet having the same texture and flexibility as normal paper.

FIG. 12 is a perspective view illustrating the configuration of an electronic notebook 1200. The electronic notebook 1200 has multiple sheets of the aforementioned electronic paper 1100 bound together within a cover 1201. The cover 1201 includes a display data input unit (not shown) through which image data sent from, for example, an external device is inputted. Accordingly, the display content can be changed or updated based on that image data while the electronic paper remains in a bound state.

As the aforementioned wristwatch 1000, electronic paper 1100, and electronic notebook 1200 employ the electrophoretic display apparatus according to the invention, they are electronic devices that include display units that achieve multi-tone displays through a simple configuration.

Note that the aforementioned electronic device is merely an example of an electronic device according to the invention, and is not intended to limit the technical scope of the invention. For example, the electrophoretic display apparatus according to the invention can be favorably used in the display units of other electronic devices, such as mobile telephones, mobile audio devices, and so on.

The entire disclosure of Japanese Patent Application No. 2009-250325, filed Oct. 30, 2009 is expressly incorporated by reference herein.

1. An electrophoretic display apparatus configured with an electrophoretic element sandwiched between a pair of substrates, and including a scanning line and a data line extending in mutually intersecting directions and a pixel formed corresponding to the area where the scanning line and data line intersect,
wherein the pixel includes a pixel electrode, a select transistor whose gate is connected to the scanning line, and a driving transistor whose gate is connected to the data line directly or via another element; and
a ramp waveform is inputted into the pixel electrode via the driving transistor.

2. The electrophoretic display apparatus according to claim 1,
wherein a second scanning line that is different than the scanning line connected to the pixel or a power source line is connected to the source of the driving transistor; and
the source of the select transistor is connected to the drain of the driving transistor.

3. The electrophoretic display apparatus according to claim 1,
wherein a second scanning line that is different than the scanning line connected to the pixel or a power source line is connected to the source of the driving transistor; and
the drain of the select transistor is connected to the gate of the driving transistor.

4. The electrophoretic display apparatus according to claim 2, wherein the second scanning line and the scanning line connected to the pixel are adjacent to each other.

5. The electrophoretic display apparatus according to claim 1, wherein a pulse having a pulse width that is no greater than a selection period of the pixel is inputted into the gate of the driving transistor.

6. The electrophoretic display apparatus according to claim 1, wherein the ramp waveform is supplied to the pixel only during a period during which a potential that puts the select transistor into an on state is inputted into the scanning line.

7. The electrophoretic display apparatus according to claim 6,
wherein a power source main line that supplies the ramp waveform to a display unit and a power source line that is formed in correspondence with the scanning line and that supplies the ramp waveform to the pixel are provided;
the power source line is connected to the power source main line via a power source unit transistor; and
the scanning line is connected to the gate of the power source unit transistor.

8. A driving method for an electrophoretic display apparatus, the electrophoretic display apparatus configured with an electrophoretic element sandwiched between a pair of substrates and including a scanning line and a data line extending in mutually intersecting directions and a pixel formed corresponding to the area where the scanning line and data line intersect, and being provided with a pixel electrode, a select transistor whose gate is connected to the scanning line, and a driving transistor whose gate is connected to the data line directly or via another element for the pixel, the method comprising, when an image is displayed in a display unit:
putting the pixel in a selected state by putting the select transistor into an on state in a state where a ramp waveform is supplied to the source of the driving transistor; and
inputting part or all of the ramp waveform into the pixel electrode by selectively putting the driving transistor into an on state during a predetermined period while the select transistor is in an on state.

9. The driving method for the electrophoretic display apparatus according to claim 8, wherein the ramp waveform is supplied to the driving transistor via a second scanning line that is different than the scanning line connected to the pixel.

10. The driving method for the electrophoretic display apparatus according to claim 9, wherein the second scanning line and the scanning line connected to the pixel are adjacent to each other.

11. An electronic device comprising the electrophoretic display apparatus according to claim 1.

12. An electronic device comprising the electrophoretic display apparatus according to claim 2.

13. An electronic device comprising the electrophoretic display apparatus according to claim 3.

14. An electronic device comprising the electrophoretic display apparatus according to claim 4.

15. An electronic device comprising the electrophoretic display apparatus according to claim 5.

16. An electronic device comprising the electrophoretic display apparatus according to claim 6.

17. An electronic device comprising the electrophoretic display apparatus according to claim 7.
